(19) United States
(12) Patent Application Publication
(10) Pub. No.: US 2024/0128795 A1
(43) Pub. Date: Apr. 18, 2024

(54) ALARM

(71) Applicant: Lewis Anten, Encino, CA (US)

(72) Inventor: Lewis Anten, Encino, CA (US)

(21) Appl. No.: 18/384,852

(22) Filed: Oct. 28, 2023

Related U.S. Application Data
(63) Continuation of application No. 17/968,527, filed on Oct. 18, 2022, now abandoned.

(51) Int. Cl. H02J 50/00; H02J 50/10

(52) U.S. Cl. CPC H02J 50/005; H02J 50/10

(57) ABSTRACT

A personal alarm includes a rechargeable power supply that is capable of powering the personal alarm and also charging a rechargeable Li-Ion battery in an electronic device, such as a cellphone and wireless inductive coils for wireless charging electronic devices such as cellphones and digital watches.

### BACKGROUND

Existing personal alarms use a power supply, either button cells or Lithium-Ion batteries, also referred to as Li-Ion batteries, to power the alarm. The Li-Ion battery required to power the alarm is typically 200 mah. This is enough to power the alarm. However, 200 mah is not sufficient for charging the battery pack or a cellphone. When charging a cellphone if the cellphone battery is completely discharged then a portion of a battery pack is used just getting the cellphone to its operative stage. If a battery pack is only 200 mah the battery pack might not even get the cellphone operative. The cellphone is completely discharged and a 500 mah battery pack is used, then approximately 150-200 of the 500 mah is used to start the phone up, and only 300-350 mah is added to the charge of the battery of the cellphone. However, if the cellphone battery is not completely discharged when the battery pack is used, then substantially all of the 500 mah is available for charging the cellphone battery. Also, since an external battery pack operates at less than its rated mah due to lower wattage than 5V and power conversion the actual mah delivered to the battery in the cellphone may be only ⅔ of the external battery pack. To cover both situations, dead and operative, a battery pack of at least 500 mah is needed.

Having a Li-Ion battery power both the alarm, and possibly an LED light in the alarm, and also serve as a cellphone battery charger permits one circuit to be used, saving cost of manufacture and also permits saving of space, particularly when the alarm and battery power pack is needed to be carried on one's person, a keychain, or in a pocket. The use of a single power supply also saved space and cost of manufacture.

It is also desirable to have a portion of the power of that battery pack be preserved when charging a cell phone so that there is sufficient battery power to continue to operate the alarm and/or LED light. For example, if a 500 mah Li-Ion battery is used, the charging of the cellphone will stop when the power of the Li-Ion battery drops below, for example 150 mah. This would permit the cell phone to be charged to some extent and at the same time not interfere with the operation of the alarm or LED light functions. There can also be a switch to override this reserve feature so that the entire contents of the Li-Ion battery can be used to charge the cellphone.

Also, by having male outputs from the Li-Ion battery to the cellphone eliminates the need to have a separate power cord. Absent the male outlet, the user would have to carry a connector to connect the battery supply to the cellphone. While, reference is used for powering a cellphone, there are numerous other Li-Ion powered products that also are powered by a Li-Ion battery, such as ear pods, and the Li-Ion battery in the alarm could also be used to power those products. The cellphone is by far the most prevalent product that requires a battery backup. Also there are anti-theft alarms that sense movement or vibration of the alarm to prevent theft of items such as bicycles or backpacks.

Typical cellphones that are sold today include an inductive charging capability whereby inductive charging coils from an external power source charge the cellphone battery without any contact, such as from a cable our power output source. Today a universal standard known as Qi is used in wireless chargers for charging virtually all cell phones.

In addition, digital watches such as the Apple Watch, have docking stations for wirelessly charging digital watches. Typically, such docking stations are connected to a source of power via a cable having a male USB-A at one end and the Apple Watch docking station at the other

### BRIEF DESCRIPTION OF THE DRAWINGS

FIG. 1 is an internal circuit diagram of the prior art personal alarm with a LED light.

FIG. 2 is a circuit diagram of the components of a personal alarm of the present invention.

FIG. 3 is a circuit diagram of the components of the present invention.

FIG. 4 is a circuit diagram of an alternate version of the invention of FIG. 3.

FIG. 5 is a diagrammatic view of the present invention showing the pivoting male output connector port from an extended position to an internal position.

FIG. 6 is a diagrammatic view of an alternative embodiment of the present invention showing wireless chargers and motion sensing circuitry.

FIG. 7 is a top perspective view of the casing for the embodiment shown in FIG. 7.

### OBJECTS OF THE PRESENT INVENTION

It is an object of the present invention to provide an improved alarm that has more uses.

It is another object of the present invention to provide an improved alarm that is more reliable.

It is yet another object of the present invention to provide an improved alarm that is cheaper to manufacture.

It is yet another object of the present invention to provide an improved alarm that is more reliable.

It is yet another object of the present invention to provide an improved alarm that has a longer battery life.

It is yet another object of the present invention to provide an improved alarm that also acts as a Li-Ion battery charger.

It is yet another object of the present invention to provide a battery pack that includes a docking station for charging wireless devices, including cellphones;

Another object to the present invention is to provide a battery pack having a docking station for charging a digital watch such as an Apple Watch.

These and other objects of the present invention will be apparent from the following specification and accompanying drawings.

### DETAILED DESCRIPTION OF THE DRAWINGS

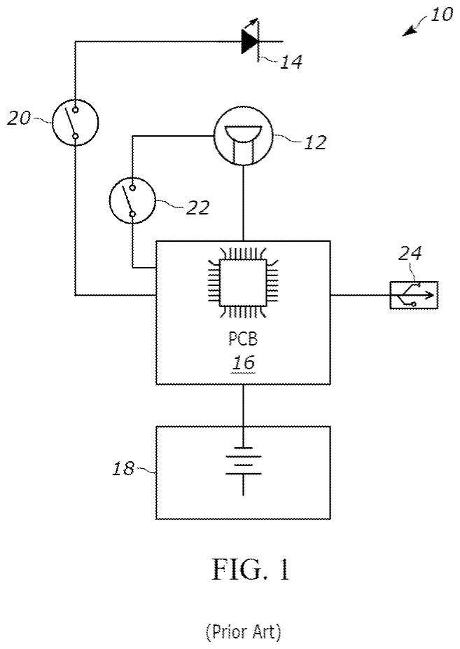

FIG. 1 is a circuit diagram of the prior art personal alarm 10. The personal alarm 10 includes an alarm 12, an LED light 14 a printed circuit board PCB 106 for controlling the operation of the alarm 12 and the LED light 14 and a power supple 18 connected to the PCB 106. On/off switches 22 and 20 control the power to the alarm 12 and the light 14. There are two types of switches for activating the alarm. The first type of switch is a pushbutton switch. Pushing the switch causes the alarm to be activated. A second type of switch is a switch that has a member that interrupts the power to the alarm when the member is in place and permits power to the alarm when the member is removed.

A USB power input port 24 is provided in the event that the power supply 18 is a rechargeable battery. In the prior art, button cell batteries and Li-Ion batteries are used. The Li-Ion batteries are rechargeable. The PCB 106 has circuitry for permitting the alarm 12 and the LED light 14 to be cyclically operated so that there is not a steady sound or light, but rather a beeping sound and flashing light. The alarm 12 typically creates a 120-130 DB sound. The PCB 106 also includes appropriate circuitry for controlling the power input to the Li-Ion power supply 18, including safety controls to prevent the Li-Ion power supply 18 from overheating.

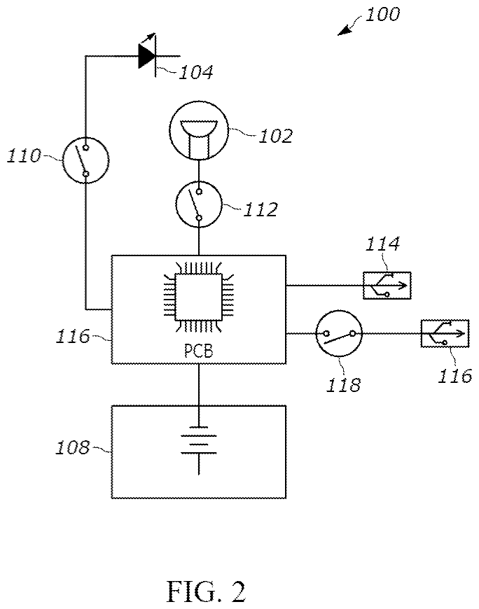

FIG. 2 shows a first embodiment of the present invention. The device of FIG. 2, in addition to having the alarm 102 and the LED light 104 and the rechargeable Li-Ion power supply 108 and USB input power supply input 114 there is a USB-A female power output port 116 having an on/off switch 118. The PCB 106 includes circuitry for controlling the power output from the Li-Ion power supply 108. The female USB-A output port 110 is adapted to receive a connector cable (not shown) that has a USB-A male connector at one end of the cable and a male power input port adapted to connect to the power input port of a cellphone or other electronic device. In the case of cellphones, the male power output of the cable is typically a micro USB for Android type cellphones, a Lighting connector for Apple cellphones or a USB-C for Google cellphones.

In one embodiment of the present invention, the PCB 106 can also include circuitry for limiting the amount of power that the Li-Ion power supply 108 will supply to the cellphone or electronic device being charged so that the charging of the device does not deplete all of the power of the Li-Ion power supply 108. Limiting the amount of power used in charging a device will leave sufficient power to still activate the alarm and/or LED lights for use.

A current cutoff circuit for preventing further discharge of the Li-Ion battery when used to charge an electronic device when a minimum voltage is reached is well known in the field of electronics. Such circuits typically include a circuit containing a voltage divider and transistors. Any cutoff circuit, including a single R-C circuit, can be used to prevent further discharge of the Li-Ion battery power supply when the desired minimum voltage limit is reached; therefore preserving power to operate the alarm 102 and/or LED light 104.

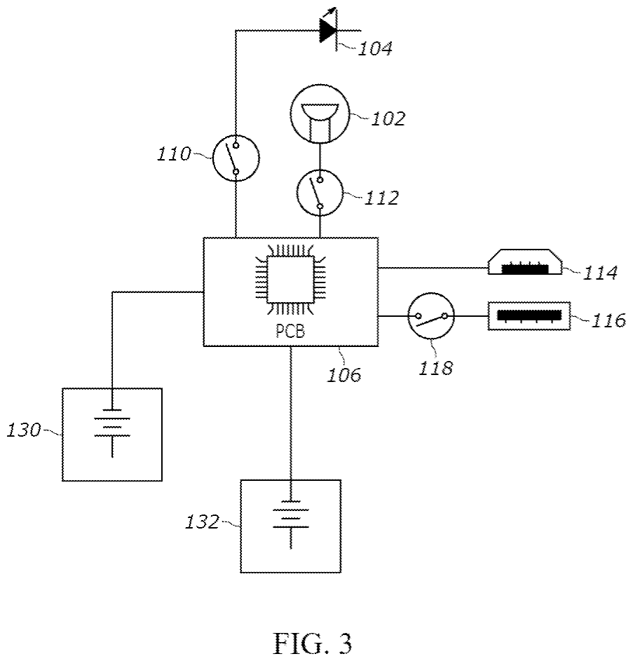

FIG. 3 is an alternative embodiment in which there are two power supplies, 130 and 132. At least one of the power supplies 130 is a rechargeable Li-Ion power supply for charging other electronic devices and the other power supply 132 can be button cell batteries, conventional batteries or a Li rechargeable battery for operating the alarm 102 and/or LED light 104.

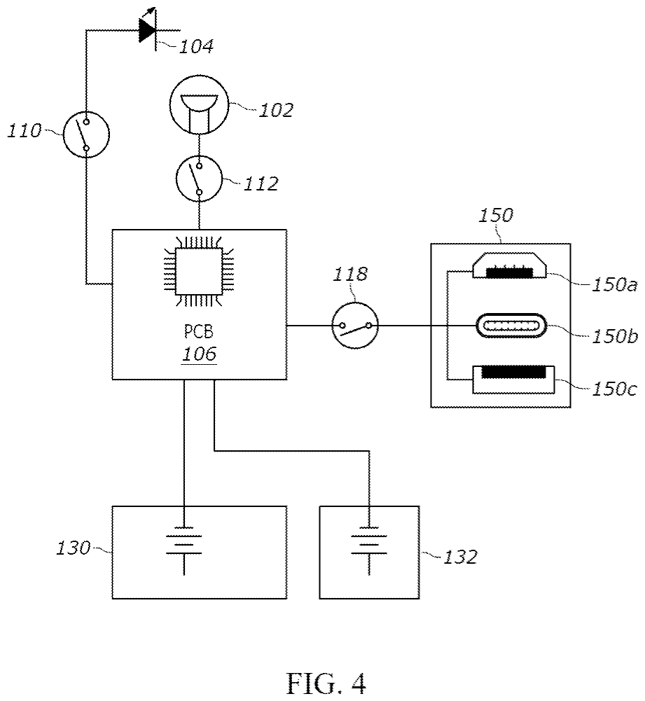

FIG. 4 is an alternative embodiment of the present invention in which, rather than having a single USB-A power output port there is a male power output port 150. The male power output port 150, typically a micro USB for Android type cellphones 150a, a Lightning connector for Apple cellphones 150b or a USB-C for Google cellphones 150c. One or more of the power output ports 150a-c may be present. The use of the male power output ports 15-a-c avoids the need for having a power connector cable in order to charge an electronic device, such as a cellphone. While it is possible that only one or two of the types of male power outputs 150a-c would be present, having all three makes the device useful for charging a number of different electronic devices, not just the type of cellphone of the person having the alarm of the alarm. Having all three male power outputs 150a-c would also allow retailers to not have to offer three different versions of the alarm since one version would change all the different cellphones.

In use of the device, the power supplies would be charged and when the user wanted to operate the alarm, the on/off switch would be activated. The on/off switch would be operated again when the alarm was to be turned off. The same procedure would be for operating the light. For charging a cellphone or other device, the on/off switch 118 would be activated and the appropriate male power output 150a-c would be inserted into the power input of the device to be powered. Various lights on the device can indicate the amount of power remaining in the rechargeable Li-Ion power supply 108 or 130. Since the Li-Ion power supply 108 and 130 have only 500 mah of power, the Li-Ion power supply 108 and 130 will not completely power the cellphone unless the cellphone was close to being fully charged before the Li-Ion power supply 108 and 130 was connected to the cellphone.

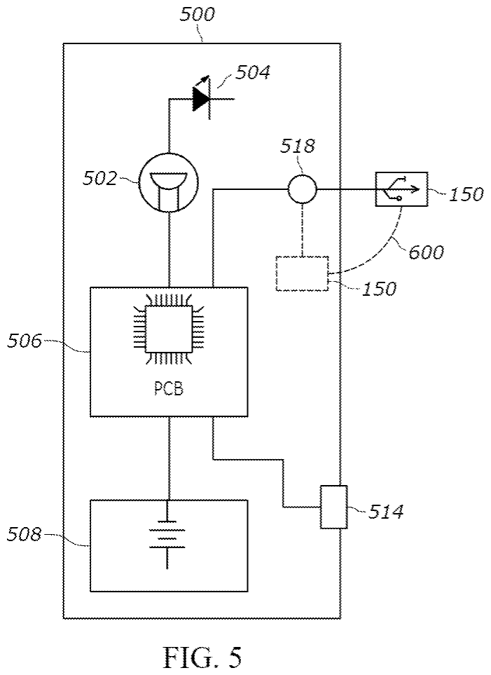

Referring to FIG. 5, the male power output connectors 150 can be concealed within the body of the alarm 500 and extracted from the body of the alarm when used. A pivot 518 connects the male power outputs 150 from an internal position to an external position as shown by dotted lines 600. Alternatively, caps can be attached to the tops of the connectors 150a-c to prevent the connectors 150a-c from getting dirty or from snagging on the clothing.

The female power input can be any available input. While historically, most female power input ports are compatible with receiving a male USB-B input connector, it is also possible to use a USB-C connector or both.

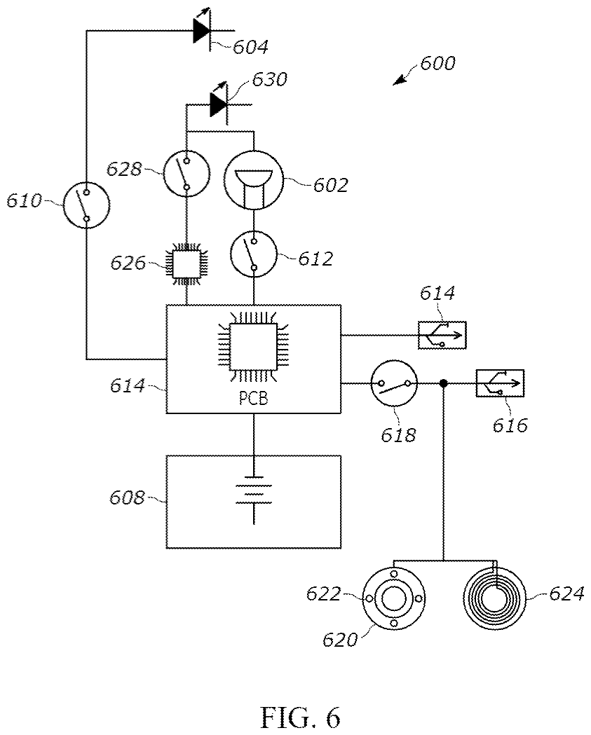

Referring to FIG. 6 the alarm 600 of the present invention is shown, including the inductive coils 620 and 624 for charging a digital watch and cellphone. The charging coil for a digital watch has positioned contacts 622 depending on the digital watch. Also shown are the USB-A output 616 and micro USB-B input 614. The switch 618 controls power to the USB-B output 616, as well as charging coils 620 and 624. The battery 608, Pcb 618, alarm 602, light 604 and switches 610 and 612 are also shown.

A typical digital watch, such as an Apple Watch has a rechargeable battery with a capacity of approximately 280 mah, which when fully charged will permit 18 hours of use. As noted above, the preferred embodiment of the alarm with battery pack, would have a li ion battery having at least 500 mah, at least a portion of the milliamp hours being reserved for the operation of the alarm. As an example, and 250 mah would be available for charging the battery of the digital watch.

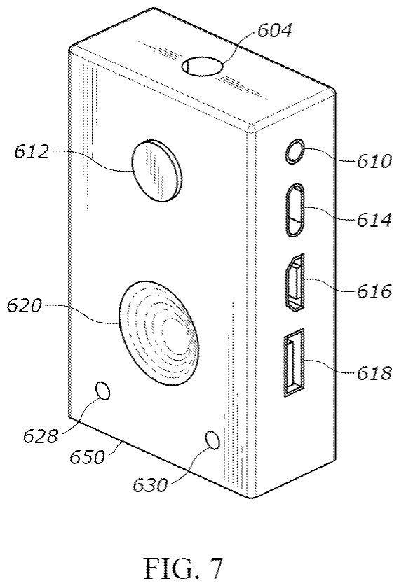

There are different digital watches that have rechargeable batteries. The Apple Watch has a convex configuration so that the docking station 620 on the present invention as shown in FIG. 7 has a corresponding concave configuration.

Referring to FIG. 7, motion sensing circuitry 626 is provided so the personal alarm 600 acts as an anti-theft alarm. The motion sensing circuitry 626 can be included in the PCB 614, which includes circuitry for controlling the power output from the battery, as well as the alarm 602, the LED 604 and the wireless chargers 620 and 624.

The motion sensing circuitry 626 would activate the alarm 602 when switch 628 is turned to its closed “on” position and motion is detected by the motion sensing circuitry 626. The motion sensing circuitry 626 can have preset delays so that the alarm 602 will not be activated when the switch 628 is “on” and the personal alarm 600 is being placed on a bicycle or in a backpack or the personal alarm 600 is being picked up to be deactivated. For example, turning the switch 628 “on” and moving the personal alarm 600 would not cause the alarm to sound for 15 seconds and thereafter, moving the personal alarm 600 to turn the switch 628 to its “off” position, would not cause the alarm to sound for 10 seconds, providing time to turn switch 628 to its off position. An LED light 630 can be used to indicate that the switch 628 is in its “on” position. Referring to FIG. 8, the external case 650 for the personal alarm 600 is shown, along with its corresponding components described above.

While the description of the personal alarm 600 above includes the alarm 612, docking station 620 and motion sensing circuitry 626, not all of these features need be included in the personal alarm 600. The personal alarm 600 could consist of a combination of the features, such as the alarm 612 and the wireless charging 620 and/or 622, but not include the motion sensing circuitry 626. Or it could have the alarm 612 and the motion sensing circuitry 626, but not the wireless charging 620 and/or 622.

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein. The following goes at the end of the current detailed description of the invention

Although several embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims.

1. A battery operated device comprising a personal security alarm; said alarm being capable of generating a loud audible sound; a rechargeable power supply, said rechargeable power supply having a power input port for recharging said rechargeable power supply and a power output port compatible with charging a battery operated electronic device; said rechargeable power supply having sufficient mah to activate a fully discharged cell phone.

2. The device of claim 1 in which said rechargeable power supply has at least 500 mah.

3. A battery operated device comprising a personal security alarm; said alarm being capable of generating a loud audible sound; a rechargeable power supply, said rechargeable power supply having a power input port for recharging said rechargeable power supply and a power output port compatible with charging a battery operated electronic device; said rechargeable power supply having at least 500 mah.
